(19) United States
(12) Patent Application Publication
(10) Pub. No.: US 2014/0109643 A1
(43) Pub. Date: Apr. 24, 2014

(54) WIRELESS TORQUE MEASUREMENT SYSTEM TUNING FIXTURE

(71) Applicant: HONEYWELL INTERNATIONAL INC., Morristown, NJ (US)

(72) Inventors: Natarajan Natarajan, Bangalore (IN); Vishal Malhan, Bangalore (IN); Vijay Tippanna Talikoti, Bangalore (IN)

(73) Assignee: HONEYWELL INTERNATIONAL INC., Morristown, NJ (US)

(21) Appl. No.: 13/656,292

(22) Filed: Oct. 19, 2012

(51) Int. Cl. G01L 25/00

(52) U.S. Cl. 73/1.09

(57) ABSTRACT

An assembly for use in tuning a wireless torque measurement system includes a support platform, a non-metallic rotor mount structure, a stator mount structure, and an actuator. The non-metallic rotor mount structure is rotationally mounted on the support platform and is configured to rotate about a rotational axis. The actuator is coupled to the support platform and to the stator mount structure, and is configured to selectively move the stator mount structure along a first translational axis that is parallel to the rotational axis.

### TECHNICAL FIELD

The disclosure relates to torque measurement systems, and, more particularly, to a tuning fixture that may be used to tune wireless torque measurement systems.

### BACKGROUND

A torque sensing system may measure and record torque applied to a component of a rotating system. Example rotating systems may include combustion engines, electric motors, drive shafts, and many other systems that have one or more rotating elements. A variety of different types of torque sensing systems may be used for measuring torque in rotating systems. In general, a torque sensing system may include sensors attached to the rotating portion of the system and may include stationary electronics that are located off of the rotating portion. In some examples, a slip ring and brush system may make a communication connection between rotating sensors and stationary electronics. In other examples, communication between the rotating sensors and stationary electronics is wireless.

The above-mentioned wireless torque measurement systems typically need to be tuned. This tuning can be difficult based on, for example, the range of capacitance available for tuning at a particular RF carrier frequency (such as 13.56 MHz). Moreover, the tuning values may vary based on the size of the components that comprise the systems, and the tuning procedure is most effective when factors that impact noise are minimized. Such factors may vary, but typically include metallic environment, and mechanical alignment (both radial and axial)

Hence, there is a need for a device that facilitates tuning of a wireless torque measurement system while simultaneously minimizing factors that may impact noise during tuning procedures. The present invention addresses at least this need.

### BRIEF SUMMARY

In one embodiment, an assembly for use in tuning a wireless torque measurement system includes a support platform, a non-metallic rotor mount structure, a stator mount structure, and an actuator. The non-metallic rotor mount structure is rotationally mounted on the support platform and is configured to rotate about a rotational axis. The actuator is coupled to the support platform and to the stator mount structure, and is configured to selectively move the stator mount structure along a first translational axis that is parallel to the rotational axis.

In another embodiment, an assembly for use in tuning a wireless torque measurement system includes a support platform, a non-metallic rotor mount structure, a plurality of circumferential grooves, a stator mount structure, an actuator, a fixed plate, and a slide plate. The non-metallic rotor mount structure is rotationally mounted on the support platform and is configured to rotate about a rotational axis. The circumferential grooves are formed in the rotor mount structure, and each groove has a diameter that is different from that of another groove. The actuator is coupled to the support platform and to the stator mount structure, and is configured to selectively move the stator mount structure along a first translational axis that is parallel to the rotational axis. The fixed plate is coupled to the support platform. The slide plate is disposed adjacent the fixed plate and is coupled to the actuator. The slide plate is movable relative to the fixed plate along a second translational axis that is perpendicular to the first translational axis.

Furthermore, other desirable features and characteristics of the assembly will become apparent from the subsequent detailed description and the appended claim, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIGS. 1 and 2 are block diagrams that show an example torque measurement system that determines an amount of torque being experienced by a rotor;

FIG. 3 is a schematic diagram of a rotor antenna that may be used to implement the system of FIGS. 1 and 2;

FIG. 4 is a schematic diagram of a tuning circuit and stator antenna that may be used to implement the system of FIGS. 1 and 2;

FIG. 5 is a side view of a tuning fixture that may be used to tune the system of FIGS. 1 and 2;

FIG. 6 is a front view of an actuator that may be used to implement the tuning fixture of FIG. 5; and

FIG. 7 is a top view of the tuning fixture depicted in FIG. 5.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

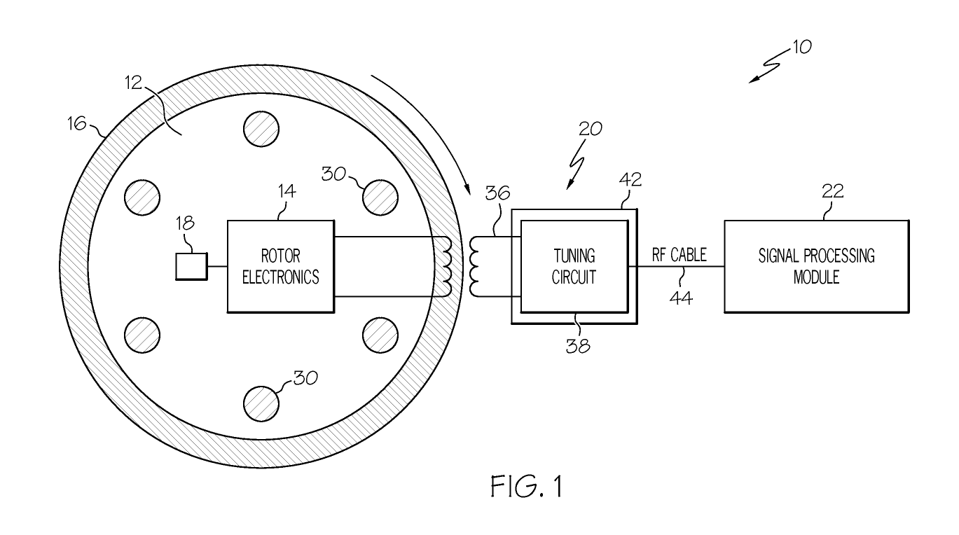

Referring first to FIGS. 1 and 2, block diagrams of an example torque measurement system 10 that determines an amount of torque being experienced by a rotor 12 are depicted. The torque measurement system 10 includes rotating components and stationary components. The rotating components include a rotor 12, rotor electronics 14, a rotor antenna 16, and one or more strain detection devices 18. The stationary components include a stator module 20, and a signal processing module 22.

Before proceeding further, it is noted that the torque measurement system 10 may be used to measure torque in numerous and varied systems. For example, the torque measurement system 10 may be used in an automotive powertrain testing system to measure torque associated with an engine, transmission, driveshaft, wheels, etc., or it may be used in a pump testing system or an electric motor testing system to measure torque at various locations in those systems.

No matter the specific system in which the torque measurement system 10 is used, the system includes at least a driving shaft 26 and an output shaft 28. The driving shaft 26 is coupled to the rotor 12, and may be driven by a non-illustrated power source, such as a combustion engine or an electric motor. The output shaft 28 is also coupled to the rotor 12. Thus, when the driving shaft 26 is rotated, it supplies a torque to the rotor 12, which in turn supplies a torque to the output shaft 28. The output shaft 28 may be a component of a testing system that may attach to a non-illustrated load.

The rotor 12 may comprise a metallic disk (e.g., a flange) that includes one or more openings 30 to facilitate its coupling to both the driving shaft 26 and the output shaft 28. In particular, the rotor 12 may be coupled to the driving shaft 26 on one side and to the output shaft 28 on the other side. For example, with respect to FIG. 2, the rotor 12 may include a first face that is coupled to the driving shaft 26 via first fasteners 32, and a second face that is coupled to the output shaft 28 via second fasteners 34.

The rotor electronics 14, the rotor antenna 16, and the strain detection device 18 are preferably mounted on the rotor 12. The strain detection device(s) 18 is (are) configured to generate strain signals representative of an amount of strain in the rotor 12. The rotor electronics 14 is coupled to receive the strain signals from the strain detection device(s) 18, and is configured to amplify the received strain signals, and to digitize the amplified strain signals to generate strain data. The rotor electronics 14 is further configured to supply power to the strain detection device(s) 18 and to transmit the strain data to the stator module 20 via the rotor antenna 16. In the depicted embodiment, the rotor electronics 14 is configured to transmit the strain data (or other data) by detuning a non-illustrated circuit in rotor electronics 14.

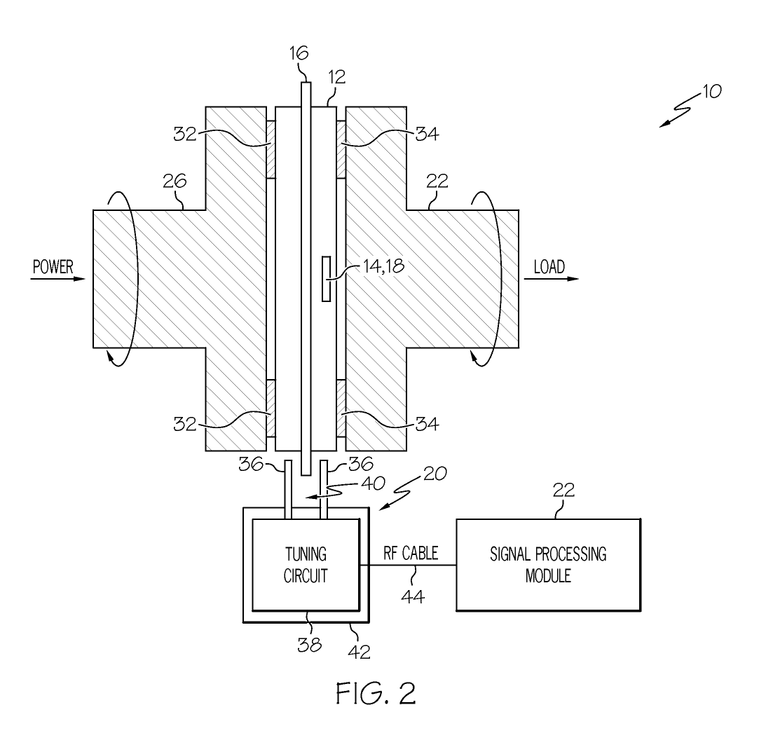

The rotor antenna 16 is coupled to, and thus rotates with, the rotor 12. In the embodiment depicted in FIGS. 1 and 2, the rotor antenna 16 is implemented as a ring that is disposed around the circumference of the rotor 12. As depicted in FIG. 3, the rotor antenna 16 is implemented using a plurality of inductors 52 (52-2, 52-2, 52-3, . . . 52-N) and capacitors 54 (54-1, 54-2, 54-3, . . . 54-N). The number of capacitors 54, and thus the number of inductors 52, may vary. However, at least one of the capacitors 54 is a rotor tuning capacitor (Cᵣₒₜₒᵣ_{_{—tune}}) that is varied during a tuning process that is implemented using a tuning fixture that is described below. In some embodiments, the rotor antenna 16 may be embedded in a non-illustrated printed circuit board (PCB) that is configured to fit around the circumference of rotor 12. Although the rotor antenna 16 is depicted as a ring that is disposed around the circumference of the rotor 12, it will be appreciated that this is merely exemplary of one embodiment, and that various other configurations could be implemented.

The stator module 20 is disposed stationary relative to rotor antenna 16, and includes a stator antenna 36 and a passive tuning circuit 38. The passive tuning circuit 38 is disposed within a housing 42, and includes various non-illustrated passive tuning elements. The stator antenna 36 extends from the housing 42, and is disposed proximate to the rotor antenna 16. Although the physical configuration of the stator antenna 36 may vary, in the depicted embodiment it includes two ears that are spaced apart to define a gap 40. The rotor antenna 16 is preferably disposed at least partially within the gap 40. During operation, the rotor antenna 16 and stator antenna 36 are preferably inductively coupled.

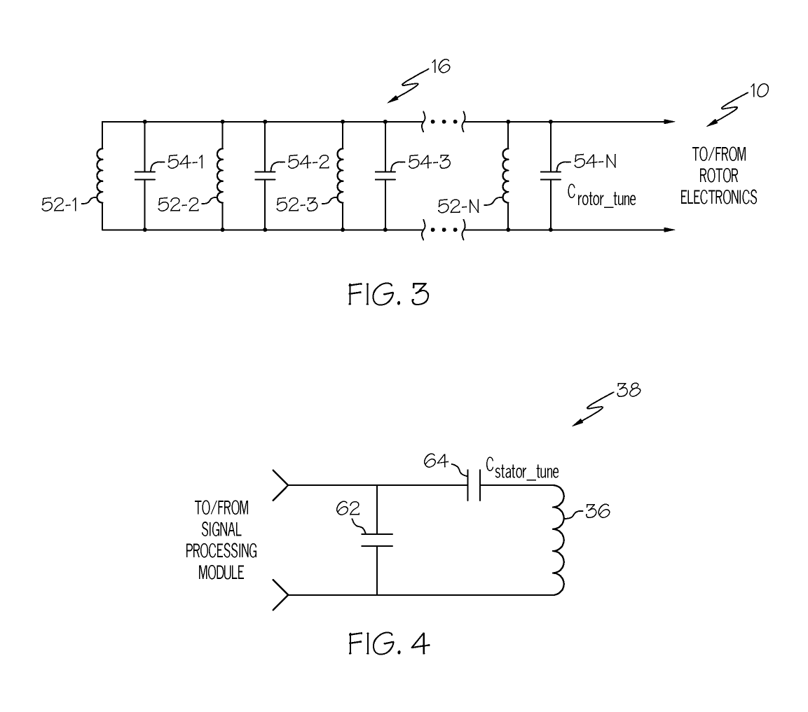

Before proceeding further, it is noted that the passive tuning elements that comprise the passive tuning circuit 38 may vary. However, in a typical embodiment, such as the one depicted in simplified schematic form in FIG. 4, the tuning circuit 38 includes at least a first stator capacitor 62 and a second stator capacitor 64. The first stator capacitor 62 is connected in parallel with the series connected second stator capacitor 64 and stator antenna 36 to form an LC circuit. In the depicted embodiment, the second stator capacitor 64 is a stator tuning capacitor (Cₛₜₐₜₒᵣ_{_{—tune}}) that is varied during a tuning process that is implemented using a tuning fixture that is described below. In other embodiments, however, the first stator capacitor 62 could be the stator tuning capacitor (Cₛₜₐₜₒᵣ_{_{—tune}}).

Returning once again to FIGS. 1 and 2, the signal processing module 22 is configured to generate an RF (radio frequency) signal. To do so, the signal processing module 22 includes an RF generator (not illustrated in FIGS. 1 and 2) that generates the RF signal (e.g., a carrier signal at 6.78 MHz or 13.56 MHz). The generated RF signal is supplied to the stator antenna 36, via the passive tuning circuit 38 and RF cable 44, for transmission from the stator antenna 36 to the rotor antenna 16. Preferably, the rotor electronics 14 is powered by the RF signal generated by the signal processing module 22. The rotor electronics 14 and the signal processing module 22 are configured to intercommunicate via antennas 16, 36, both while rotor 12 is rotating and while it is stationary. Thus, the rotor electronics 14 may be powered by the RF signal both when the rotor 12 is rotating and when it is stationary.

The signal processing module 22 may also be configured to transmit data to the rotor electronics 14 by, for example, varying the amplitude of the generated RF signal. Although the type of data may vary, in some embodiments these data may include gain values, or various other values that the rotor electronics 14 may use to determine gain values. In the depicted embodiment, the RF signal is supplied to the passive tuning network 38 via using an RF cable 44. In other embodiments, in which the RF generator 22 is disposed within the same housing 42 as passive tuning circuit 38, the RF cable 44 is not needed.

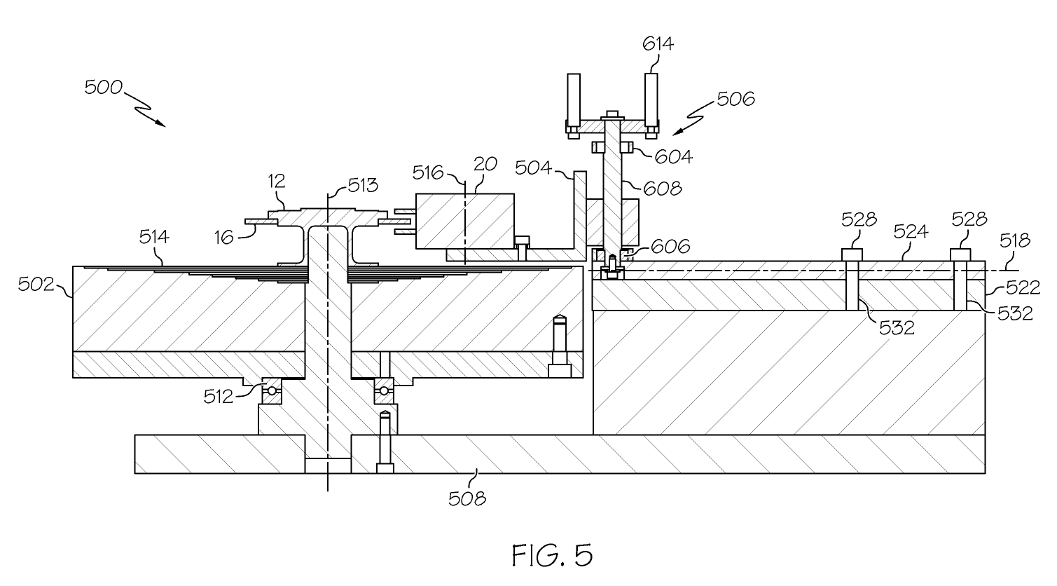

The torque measurement system 10 described above operates on the principle of wireless telemetry between the rotor 12 and the stator module 20. Thus, as previously noted, the rotor 12 and stator module 20 are preferably tuned to ensure sufficient power transfer and data recovery. The tuning processes for the rotor 12 and the stator module 20 are different, and are most effectively achieved via use of the tuning fixture that is depicted in FIG. 5, and which will now be described.

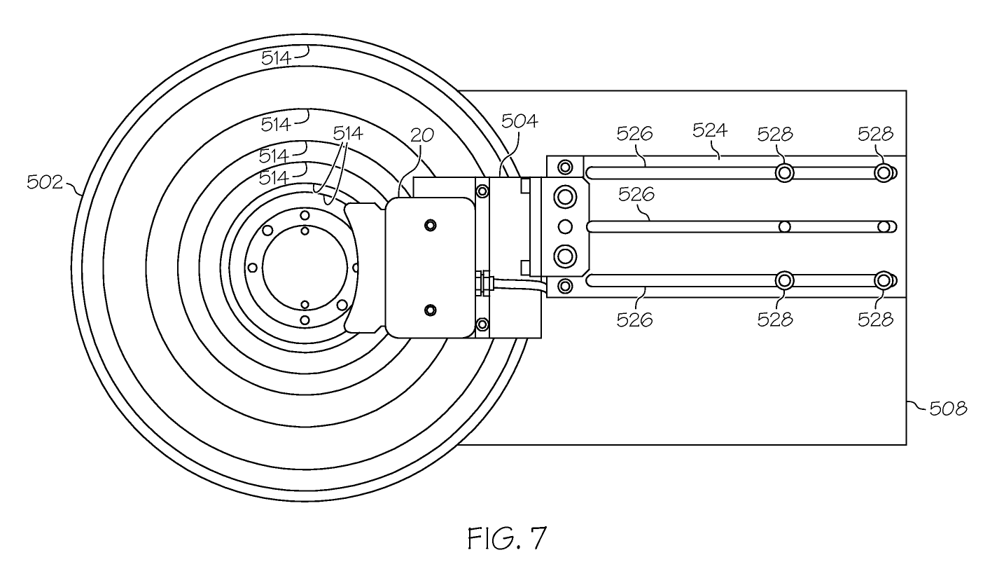

The depicted tuning fixture 500 includes a rotor mount structure 502, stator mount structure 504, an actuator 506. The rotor mount structure 502 is rotationally mounted on a support platform 508 via a thrust bearing 512, and may thus be rotated about a rotational axis 513. The rotor mount structure 502 is formed of any one of numerous types of non-metallic materials. In the depicted embodiment, however, the rotor mount structure 502 is formed of hylam. The rotor mount structure 502 has a plurality of circumferential grooves 514 formed therein (see also FIG. 7). The grooves 514 have different diameters to allow rotors of different sizes to be mounted therein for tuning. Although not depicted in FIG. 5, the tuning fixture 500 may also include a suitable locking device to prevent the rotor mount structure 502 from rotating after it has been rotated to a desired position.

The stator mount structure 504 is coupled to the support platform 508, and is disposed adjacent to the rotor mount structure 502. More specifically, the stator mount structure 504 is coupled to the actuator 506, which is in turn mounted on the support platform 508. The stator mount structure 504 is configured to have the stator module 20 securely mounted thereon. Although its physical implementation may vary, in the depicted embodiment the stator mount structure 504 comprises an L-bracket.

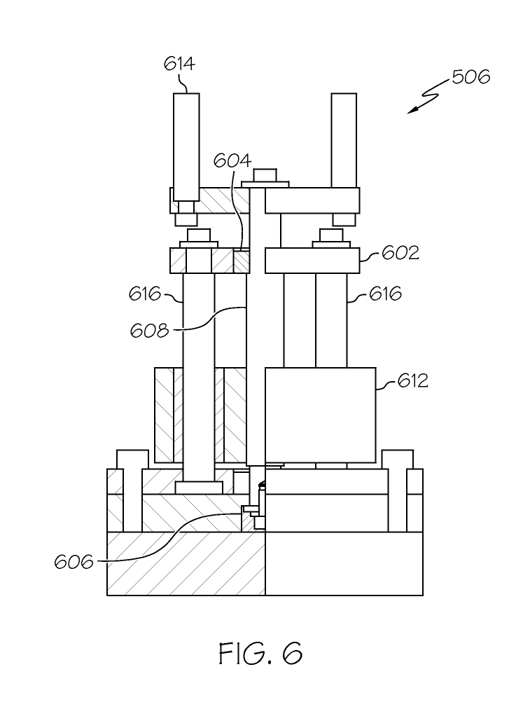

The actuator 506 is configured to move the stator mount structure along a first translational axis 516 that is parallel to the rotational axis 513 of the rotor mount structure 502. Thus, the actuator 506 is used to provide fine position adjustment of the stator module 20, along the translational axis 516, relative to the rotor antenna 16. The actuator 506 may be variously configured to implement this function, but as shown more clearly in both FIG. 5 and FIG. 6, the depicted actuator 506 includes a mount yoke 602, an upper radial bearing 604, a lower radial bearing 606, a lead screw 608, a mount block 612, and an input device 614. The mount yoke 602 is used to secure the actuator 506 in place, via suitable mount hardware 616, and has the upper and lower radial bearings 604, 606 mounted therein.

The lead screw 608 extends through the mount yoke 602, the upper and lower radial bearings 604, 606, and the mount block 612, and is coupled to the input device 614. The lead screw 608 is configured, upon rotation of the input device 614, to rotate and cause the mount block 612 to translate along the first translational axis 516. The mount block 612 is coupled to the stator mount structure 504. Thus, translation of the mount block 612 causes like translation of the stator mount structure 504.

Returning once again to FIG. 5, the tuning structure 500 is also configured to allow the stator module 20 to be positioned along a second translational axis 518 that is perpendicular to the first translational axis 516 to accommodate the different sized rotors. To implement this functionality, the tuning structure 500 additionally includes a fixed plate 522 and a slide plate 524. The fixed plate 522 is fixedly coupled to the support platform 508. The slide plate 524, however, is movably coupled to the fixed plate 522. More specifically, and as depicted more clearly in FIG. 7, the slide plate 524 has a plurality of grooves 526 formed therein. A plurality of clamping devices 528 extend through selected ones of the grooves 526 and into threaded openings 532 in the fixed plate 522 (see FIG. 5). To move the slide plate 524, and thus the stator mount structure 504 (and stator module 20 when mounted thereon), along the second translational axis 518, the clamping devices 528 are loosened, and the slide plate 524 is moved. When the desired position is achieved, the clamping devices 528 are again tightened to lock the slide plate 524 in place. Preferably, the fixed plate 522, the slide plate 524, and the clamping devices 528 are comprised, at least partially, of a non-metallic material.

The tuning structure described herein allows the torque measurement system 10 to be tuned with relatively high precision. Moreover, because the number and size of metallic parts is minimized, the tuning procedure conducted using the fixture is relatively robust.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claim.

What is claimed is:

1. An assembly for use in tuning a wireless torque measurement system, the assembly comprising:
a support platform;
a non-metallic rotor mount structure rotationally mounted on the support platform and configured to rotate about a rotational axis;
a stator mount structure; and
an actuator coupled to the support platform and to the stator mount structure, the actuator configured to selectively move the stator mount structure along a first translational axis that is parallel to the rotational axis.

2. The assembly of claim 1, further comprising:
a fixed plate coupled to the support platform;
a slide plate disposed adjacent the fixed plate and coupled to the actuator, the slide plate movable relative to the fixed plate along a second translational axis that is perpendicular to the first translational axis.

3. The assembly of claim 2, wherein the fixed plate and slide plate each at least partially comprise a non-metallic material.

4. The assembly of claim 2, wherein:
the fixed plate has a plurality of treaded openings formed therein;
the slide plate has a plurality of grooves formed therein; and
the assembly further comprises a plurality of clamping devices, each clamping device extending through one of the grooves and into one of the threaded openings.

5. The assembly of claim 1, further comprising:
a plurality of circumferential grooves formed in the rotor mount structure, each groove having a diameter that is different from that of another groove.

6. The assembly of claim 1, wherein the stator mount structure comprises an L-bracket.

7. The assembly of claim 1, wherein the actuator comprises:
a mount yoke coupled to the support structure; and
a lead screw extending through the mount yoke and coupled to the stator mount structure, the lead screw configured to rotate and, upon rotation, to cause movement of the stator mount structure along the first translational axis.

8. The assembly of claim 7, wherein the actuator further comprises:
an input device coupled to the lead screw, the input device configured to receive an input torque and, upon receipt thereof, to rotate the lead screw.

9. The assembly of claim 1, further comprising:
thrust bearing coupled to the support platform and the rotor mount structure to rotationally mount the rotor mount structure to the support platform.

10. An assembly for use in tuning a wireless torque measurement system, the assembly comprising:
a support platform;
a non-metallic rotor mount structure rotationally mounted on the support platform and configured to rotate about a rotational axis;
a plurality of circumferential grooves formed in the rotor mount structure, each groove having a diameter that is different from that of another groove;
a stator mount structure;
an actuator coupled to the support platform and to the stator mount structure, the actuator configured to selectively move the stator mount structure along a first translational axis that is parallel to the rotational axis;
a fixed plate coupled to the support platform; and
a slide plate disposed adjacent the fixed plate and coupled to the actuator, the slide plate movable relative to the fixed plate along a second translational axis that is perpendicular to the first translational axis.

11. The assembly of claim 10, wherein the fixed plate and slide plate each at least partially comprise a non-metallic material.

12. The assembly of claim 10, wherein:
the fixed plate has a plurality of threaded openings formed therein;
the slide plate has a plurality of grooves formed therein; and
the assembly further comprises a plurality of clamping devices, each clamping device extending through one of the grooves and into one of the threaded openings.

13. The assembly of claim 10, wherein the stator mount structure comprises an L-bracket.

14. The assembly of claim 10, wherein the actuator comprises:
a mount yoke coupled to the support structure; and
a lead screw extending through the mount yoke and coupled to the stator mount structure, the lead screw configured to rotate and, upon rotation, to cause movement of the stator mount structure along the first translational axis.

15. The assembly of claim 14, wherein the actuator further comprises:
an input device coupled to the lead screw, the input device configured to receive an input torque and, upon receipt thereof, to rotate the lead screw.

16. The assembly of claim 10, further comprising:
thrust bearing coupled to the support platform and the rotor mount structure to rotationally mount the rotor mount structure to the support platform.
